(19) United States
(12) Patent Application Publication
(10) Pub. No.: US 2008/0154703 A1
(43) Pub. Date: Jun. 26, 2008

(54) RETAILER COMPETITION BASED ON PUBLISHED INTENT

(75) Inventors: Gary W. Flake, Bellevue, WA (US); Lili Cheng, Bellevue, WA (US); Jeffrey R. Hemmen, Renton, WA (US); Alexander Gounares, Kirkland, WA (US); David M. Chickering, Bellevue, WA (US); Eric J. Horvitz, Kirkland, WA (US); Michael Connolly, Seattle, WA (US); Kamal Jain, Bellevue, WA (US); George P. Moromisato, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/959,844

(22) Filed: Dec. 19, 2007

Related U.S. Application Data
(60) Provisional application No. 60/870,926, filed on Dec. 20, 2006.

(51) Int. Cl. G06F 17/00; G06Q 30/00

(52) U.S. Cl. 705/10

(57) ABSTRACT

The claimed subject matter relates to an architecture that can facilitate enhanced experiences in connection with consumer shopping and/or vendor advertising. The architecture can receive an intent parameter that relates to a shopping objective of a shopper, associate the shopper with a profile, receive a set of advertisements from one or more vendors, and select a suitable advertisement for display to the shopper based upon the intent parameter and/or the profile. The architecture can also maintain a veracity score for the shopper that can indicate the shopper's tendencies to follow through with objectives listed in the intent parameters. The veracity score can be utilized, e.g., as a benchmark for bidding advertisers.

### CROSS-REFERENCE TO RELATED APPLICATIONS

This application claims the benefit of U.S. Provisional Application Ser. No. 60/870,926, filed Dec. 20, 2006, entitled “ARCHITECTURES FOR SEARCH AND ADVERTISING.” This application is related to U.S. application Ser. No. 11/767,360, filed on Jun. 22, 2007, entitled “MOBILE AD SELECTION AND FILTERING.” This application is related to U.S. application Ser. No. 11/862,766, filed on Sep. 27, 2007, entitled “SHOPPING ROUTE OPTIMIZATION AND PERSONALIZATION.” This application is related to U.S. application Ser. No. (MSFTP2017US) ______, filed on ______, entitled “FEEDBACK LOOP FOR CONSUMER TRANSACTIONS.” The entireties of these applications are incorporated herein by reference.

### BACKGROUND

Conventional retail forums of vendors—whether brick and mortar or online marketplaces—offer little in the way of pricing power for the average consumer or shopper. While reverse auctions mechanisms exist in part to shift pricing power to consumers, these mechanisms often have low liquidity and are not typically useful in normal business-to-consumer (B2C) transactions. Thus, the primary manner of dealing with this difficulty is to offer promotional discounts or the like. However, while promotional offers, coupons, or other discounts can provide a means for the consumer to receive more bang for the buck, these offers only very rarely align, often only by pure happenstance, with a given shopper's present needs or shopping objectives.

One conventional answer to this difficulty is to place coupon dispensers at the shelves including the products that are discounted, thereby providing a mechanism for these advertisements to be utilized by shoppers who already intend to buy the product without the need to spend time cutting coupons. By and large, however, such devices are mainly intended to solicit shoppers who do not intend to buy that particular product, but notice the coupon and decide to do so. Moreover, such devices, while useful for the manufacturer of the advertised product, offer only marginal if any benefit to the retailer, as any shopper who notices such coupons is necessarily already patronizing the retailer to further his or her shopping objectives.

A primary difficulty is that vendors typically do not have any means of discovering what the objectives of a given shopper are. Thus, vendors typically have no way of meeting or providing for these intents. Conversely, a shopper does not typically have any means of indicating to vendors what his or her intentions are, even though it could be very beneficial for the shopper to indicate presence, objectives, and other intentions and allow the suitable vendors to advertise or compete to meet those ends in the most satisfactory way to the shopper.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can facilitate enhanced experiences in connection with consumer shopping and/or vendor advertising. To these and other related ends, the architecture can provide a mechanism by which a shopper can input intent parameters that relate to the shopper's specific shopping objectives such as items to buy, people for whom to buy, a current location, an intended shopping destination, a time in which the shopping will take place or length of time intended for the shopping session, an intended budget, and so on.

In addition, the architecture can identify the shopper by one of several means, commonly based upon a device ID from, e.g., a mobile device, and, based upon the ID, associate the shopper with a profile that can include transaction histories, shopping preferences, demographic data as well as a veracity score. The veracity score can reflect the tendency of the shopper to fulfill the objectives set forth by the intent parameter. For example, the shopper who inputs intent parameters and ultimately completes transactions that pertain to the published intentions/shopping objectives will typically have a superior veracity score.

In addition, the architecture can receive a set of advertisements from one or more vendors. The set of advertisements can be received either after or prior to receipt of the intent parameter and can be in some cases solicited by the architecture. In particular, the architecture can determine an appropriate subset of vendors to solicit based upon the intent parameters, the profile, and/or the veracity score. The solicitation can, but need not include portions of the intent parameter, profile, or veracity score. In another aspect, the architecture can provide a bidding mechanism such that vendors can bid to increase the likelihood that the bidder's advertisements will be selected. The bidding can be contingent upon the veracity score. Hence, vendors will typically bid more for superior veracity scores, or for veracity scores that include desired characteristics.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a system that can facilitate enhanced experiences in connection with consumer shopping and/or vendor advertising.

FIG. 2 illustrates a block diagram of numerous examples of intent parameter 104.

FIG. 3 depicts a block diagram of various examples of data included in profile 110.

FIG. 4 illustrates a block diagram of a system that can solicit vendors in order to facilitate enhanced experiences in connection with consumer shopping or vendor advertising.

FIG. 5 depicts a block diagram of a system that can employ a veracity rating to solicit vendors in order to facilitate enhanced experiences in connection with consumer shopping or vendor advertising.

FIG. 6 depicts a block diagram of a system which illustrates various example topologies in connection with the claimed subject matter.

FIG. 7 depicts a block diagram of a system that can aid with various inferences.

FIG. 8 is an exemplary flow chart of procedures that define a method for facilitating richer experiences in connection with consumer shopping and/or vendor advertising.

FIG. 9 illustrates an exemplary flow chart of procedures that define a method for soliciting vendors in order to facilitate richer experiences in connection with consumer shopping and/or vendor advertising.

FIG. 10 depicts an exemplary flow chart of procedures defining a method for utilizing a veracity rating in connection with facilitating richer experiences for consumer shopping and/or vendor advertising.

FIG. 11 illustrates a block diagram of a computer operable to execute the disclosed architecture.

FIG. 12 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can, but need not, refer to a computer-related entity, either hardware, a combination of hardware and software, software, or software in execution. For example, a component might be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” generally refer to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

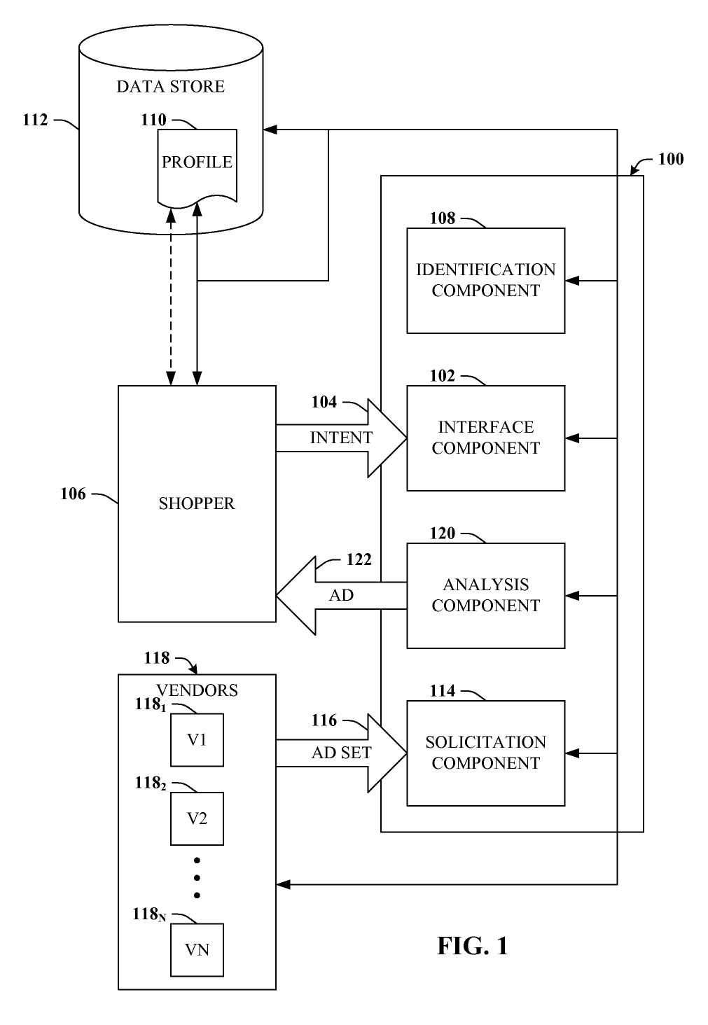

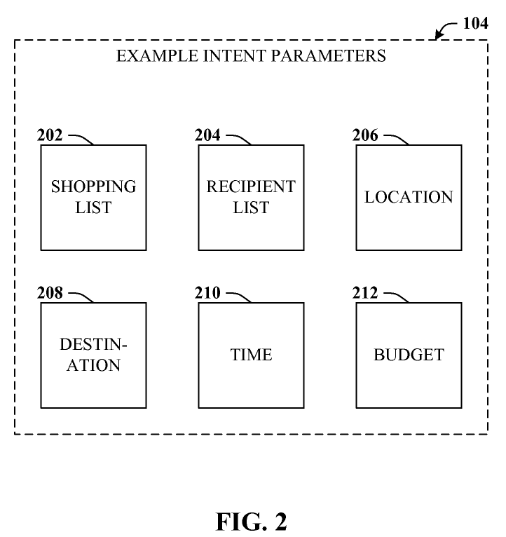

Referring now to the drawings, with reference initially to FIG. 1, system 100 that can facilitate enhanced experiences in connection with consumer shopping and/or vendor advertising is depicted. Generally, system 100 can include interface component 102 that can receive intent parameter 104. Intent parameter 104 can relate to one or more of a variety of shopping objectives of shopper 106, numerous examples of which are provided in connection with FIG. 2. Shopper 106 can be substantially any individual or entity who uses the subject matter described or claimed herein. However, shopper 106 will typically be an individual or entity who intends to make a purchase, engage in another related type of transaction, or has objectives related thereto. In some aspects, shopper 106 can be an individual or entity who is at a certain location, such as at or near an embodiment of interface component 102 or at or near a particular business establishment of a vendor.

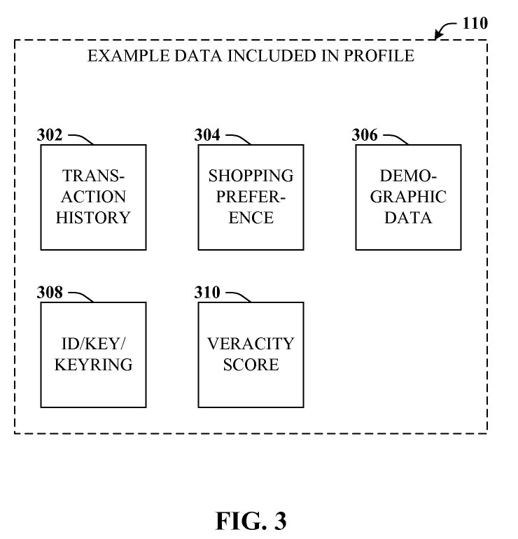

In addition, system 100 can also include identification component 108 that can associate shopper 106 with profile 110. Profile 110 can include a variety of information relating to shopper 106, many examples of which are provided with reference to FIG. 3. In many situations, profile 110 might already exist, e.g. in data store 112, which can be employed to store profile 110 as well as any other data described herein or data that is otherwise suitable and/or relevant. In such a case, profile 110 can be associated with shopper 106 based upon some form of identification or authentication such as a password, passcode, key, a device, machine, or application ID, or other type of ID, and so on.

In other cases, however, valid identification might not be obtained in order to associate shopper 106 to profile 110, or profile 110 might not yet exist. In these situations, identification component 108 can create profile 110 and populate profile 110 based upon any suitable information available at that time. This can include assigning profile 110 (and by proxy shopper 106) a suitable ID, which can be acquired from a device employed by shopper 106 to access interface component 102, and can further be referenced to other device IDs for devices employed by shopper 106 as well as a global ID unique to shopper 106. In another aspect, identification component 108 can have access to a set of template profiles (not shown) previously constructed, and can determine or infer the best profile 110 from the set of templates, again based upon any suitable information available at that time. Such information can be included in the intent parameter 104. For example, shopping list 202, time 210, budget 212 (all detailed infra in connection with FIG. 2), as well as other intent parameters 104 can be a rich source of data from which to establish a baseline for profile 110.

Appreciably, interface component 102 can receive various other data in addition to intent parameter 104. For example, interface component 102 can also receive (and in some cases request by way of a query or the like) information relevant for profiling shopper 106 and/or setting preferences for shopper 106. Hence, interface component 102 can query shopper 106 “Do you prefer browsing before buying, or buying quickly and conveniently?” Such queries, as well as other information can provide a rich source of information and can be employed to select a suitable template profile as well as to populate or create profile 110, often in an innocuous manner. It should be understood that in the event more than one profile 110 is created for a single shopper 106, identification component 108 can integrate and/or interpolate the multiple profiles 110 into a single, more comprehensive profile 110. In order to provide additional context for the claimed subject matter, FIGS. 2 and 3 can now be referenced prior to completing the discussion of FIG. 1.

Turning now to FIG. 2, numerous examples of intent parameter 104 are expressly illustrated. As noted supra, interface 102 can receive intent parameter 104, wherein the intent parameter 104 can relate to one or more shopping objectives of shopper 106. As a first example, intent parameter 104 can be or include shopping list 202. Shopping list 202 can be a list of enumerated items (e.g., products or services) shopper 106 intends to purchase at a later time, typically in the near future such as in the next shopping related outing or shopping session.

Similarly, intent parameter 104 can include or be another type of list such as recipient list 204. Recipient list 204 can include one or more intended recipients for purchased items. The intended recipient(s) can be identified by name, an ID number, or in another suitable manner, and recipient list 204 may or may not include an item that will be purchased for the intended recipient. For example, shopper 106 may know for whom a purchase is intended, but not necessarily know what to buy (e.g., a sister's birthday, a friend who is ill). Accordingly, information may be available about the intended recipient with which a determination or inference can be made to provide a recommendation to shopper 106 based upon information known (e.g. ID, profile, condition, etc.) about the intended recipient or based upon a relationship to shopper 106 (e.g., sister, friend, etc.). For example, a profile associated with one or more of the intended recipients might exist. As such, identification component 108 can locate this profile based upon, e.g., information supplied by shopper 106. In other cases, based upon the same or similar information, identification component 108 can utilize the best template profile to make the recommendation.

Still other examples of intent parameter 104 can be location 206 or destination 208. For example, shopper 106 can essentially indicate, either expressly or implicitly, “I am here and I intend to make purchases” (e.g., location 206), or similarly, “I intend to be at the city center shopping mall tomorrow” (e.g. destination 208).

Another example that can be, or be included in, intent parameter 104 can include a time-based feature depicted as time 210. For example, time 210 can refer to a current time/date, a scheduled time (e.g., an anniversary, birthday, holiday, etc. before which a particular item should be purchased), as well as an amount of time allocated to a shopping session. For instance, shopper 106 can input a desired amount of time he or she intends to spend in fulfilling the shopping objectives relating to intent parameter 104. Additionally, intent parameter 104 can include budget 212 such as a budget for a particular shopping session.

While still referencing FIG. 1, but referring now also to FIG. 3, various examples of data included in profile 110 are explicitly presented. As detailed supra, profile 110 can be associated with shopper 106 and can be utilized in numerous ways to facilitate enhanced experiences or added/augmented features in connection with shopping and advertising thereto, many of which are described herein. In accordance therewith and to other related ends, profile 110 can include transaction history 302. Transaction history 302 can relate to substantially any type of consumer transaction such as purchases (e.g. items, warranties for items), time of purchase, returns, use of coupons and/or responsiveness to promotions, and so forth.

In addition, profile 110 can include shopping preferences 304 such as a customary shopping mode for shopper 106. For example, one shopper 106 might prefer locating bargains irrespective of the amount of time it takes or other opportunity costs, while another shopper 106 might prefer to get everything he or she intends to purchase at a single location and as quickly as possible. Similarly one shopper 106 might be adverse to crowded shopping environments, while another shopper 106 disagrees with the policies or practices of certain vendors and would thus like to avoid those vendors. Naturally, other examples exist, but it should be appreciated that shopping preferences 304 can relate to many aspects of shopper 106 and can be utilized in several ways, as described infra. Moreover, shopping preferences 304 can be input by way of interface component 102, received in another way, or, in some cases, inferred. For example, interface component 102 can determine, e.g., from transaction history 302 that shopper 106 tends to buy only a few select brands of apparel. Such a determination can be reflected in shopping preference 304.

Demographic data 306 can also be included in profile 110 such as age, gender, income, as well as hobbies, interests, or viewpoints. Some demographic data 306 can be received by interface component 102, which can be input by shopper 106 or acquired in another manner. Furthermore, as with shopping preference 304, some demographic data 306 can be inferred. For example, identification component 102 can make inferences relating to data 306 from transaction history 302, e.g. by examining, items purchased, price paid, vendors patronized, etc.

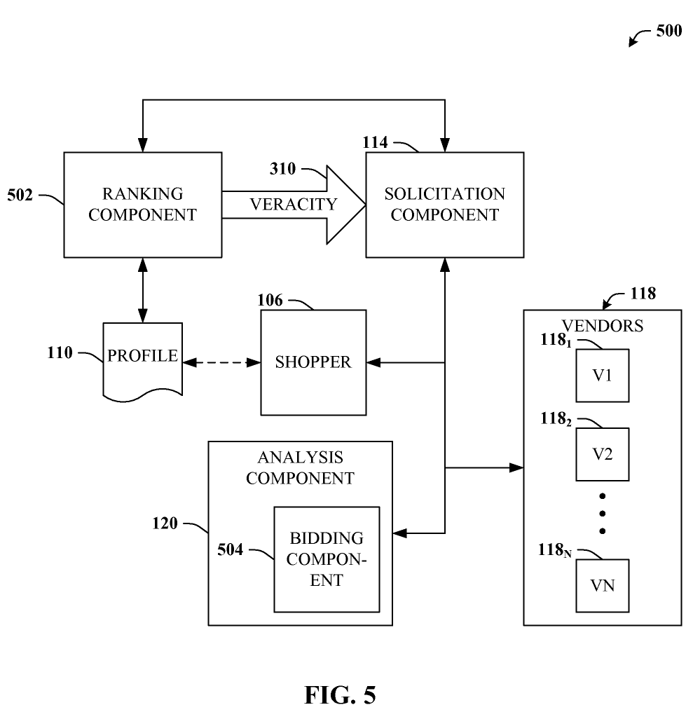

In addition, it should be understood that one or more IDs 308 can be included in profile 110. ID 308 can represent shopper 106 as well as one or more devices of shopper 106, which can be stored as keys on a keyring. According to an aspect of the claimed subject matter, profile 110 can also include veracity score 310. Veracity score 310 can relate to a tendency of shopper 106 to fulfill the shopping objectives included in intent parameter 104 and is described in greater detail in connection with FIG. 5.

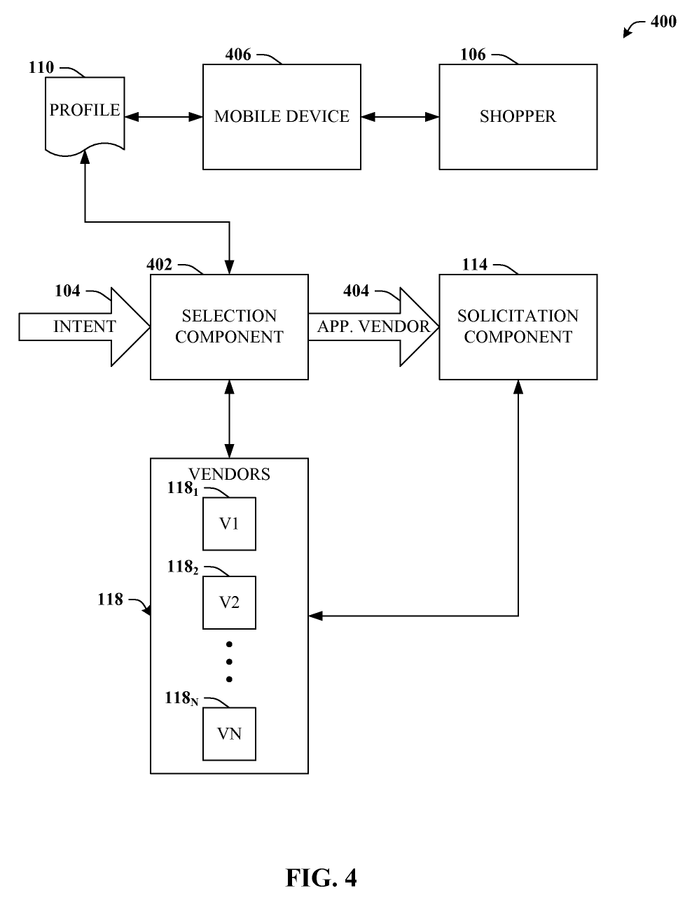

Resuming discussion of FIG. 1, system 100 can also include solicitation component 114 that can receive set 116 of advertisements from one or more vendors 118₁-118_{N}. It should be understood that vendors 118₁-118_{N} can be referred to herein, either individually or collectively as vendor(s) 118, while appreciating that one vendor 118 might have characteristics that distinguish from a second vendor 118. Moreover, vendor 118 is intended to include retailers, advertisers, or agents thereof, or substantially any business establishment that solicits transactions from consumers and/or shopper 106. It should also be understood that all or portions of set 116 can be received in advance of receipt of intent parameter 104. Additionally or alternatively, all or portions of set 116 can be received subsequent to receipt of intent parameter 104 and, according to an aspect, received in response to a solicitation resulting from receipt of intent parameter 104, as further discussed with reference to FIG. 4.

System 100 can also include analysis component 120 that can examine the set 116 of advertisements and that can further select a suitable advertisement 122 for shopper 106 based at least in part upon intent parameter 104. Additionally, according to an aspect of the claimed subject matter, analysis component 120 can select suitable advertisement 122 further based upon profile 110. To provide a series of examples to aid in understanding but not necessarily to limit the scope to only these examples, analysis component 120 can select suitable advertisement 122 based upon an item on a list (e.g., shopping list 202) or an item inferred from a list (e.g., recipient list 204). Set 116 can include several advertisements from vendors 118 carrying that item, many of which may or may not be suitable based upon other criteria included in intent parameter 104 or profile 110 due to, e.g. the cost of the item, location of the associated vendor 118, preferences 304 of shopper 106, and so on.

Likewise, intent parameter 104 can indicate an objective to spend the next four hours shopping (e.g. time 210) at a local shopping mall (e.g., location 206, destination 208). Roughly midway through the shopping session, or at an appropriate time of day, say, around noon, analysis component 120 can select an ad from a nearby gourmet restaurant as suitable advertisement 122. In another case, potentially based upon transaction history 302, shopping preferences 304, and/or budget 212, analysis component 120 might select instead advertisement 122 from a deli-style restaurant or a coffee/juice shop.

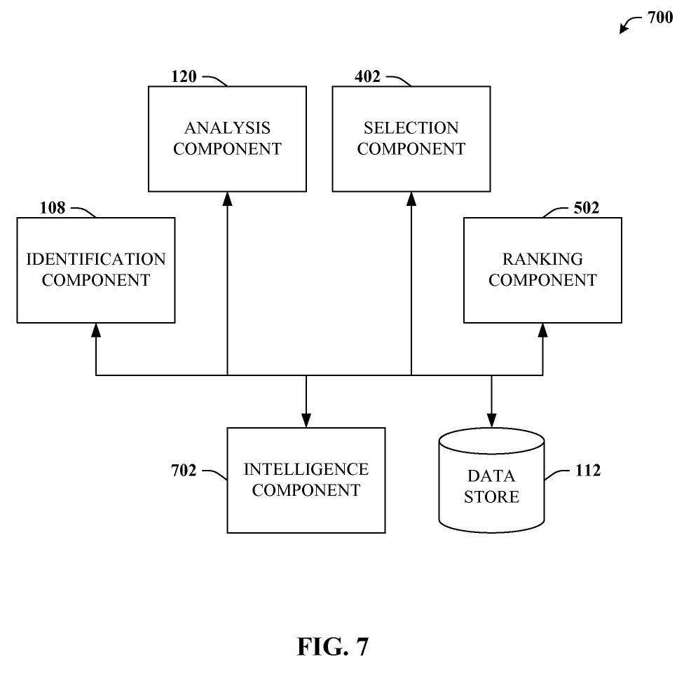

While the above examples are intended to provide context for the claimed subject matter, it should be appreciated that analysis component 120 can select suitable advertisement 122 based upon appearance or existence of criteria in intent parameter 104 or profile 110. Hence, it can be predetermined that a certain criterion or a certain combination of criteria can prompt selection of a particular suitable advertisement 122. Additionally or alternatively, analysis component 120 can dynamically determine or infer suitable advertisement 122 from set 116 by assigning probabilities or weights to various characteristics of ads in the set 116, the associated vendor 118, or features of intent parameter 104 or profile 110 and employing, e.g. Bayesian techniques for ascertaining a level of confidence as to the suitability, which is further detailed in connection with FIG. 7.

Turning now to FIG. 4, system 400 that can solicit vendors in order to facilitate enhanced experiences in connection with consumer shopping or vendor advertising is illustrated. In general, system 400 can include selection component 402 that can be operatively or communicatively coupled to all or a subset of the components described herein (e.g., components 102, 108, 114, 120). Selection component 402 can aid in and/or facilitate solicitation of set 116 of advertisements from vendors 118. In particular, selection component 402 can identify appropriate vendors 404 from amongst vendors 118 based at least in part upon intent parameter 104. In addition, selection component can identify appropriate vendor 404 further based upon profile 110.

Accordingly, based upon the same or similar aspects of intent parameter 104 or profile 110 by which analysis component 120 selects suitable advertisement 122, selection component 402 can likewise select appropriate vendor 404. As a result, solicitations and/or requests for set 116 can be transmitted to vendors 118 or, in a more specific case, only to appropriate vendor(s) 404. In particular, the identity of appropriate vendor 404 can be received by solicitation component 114, which can then deliver solicitations to, and receive responses from, vendors 118 (or potentially only from vendors 404).

Moreover, solicitation component 114 can further transmit at least a portion of intent parameter 104 to vendors 118, 404. In an aspect, solicitation component 114 can also transmit at least a portion of profile 110 to vendors 118, 404. It is to be appreciated that in some cases intent parameter 104 and profile 110 can include information shopper 106 might consider personal or private or might otherwise not wish to share. In such cases, shopper 106 can restrict or place constraints upon sharing such information by way of shopping preferences 304. However, in many cases intent parameter 104 and profile 110 can include information that is not especially private or sensitive, but might be useful nonetheless to vendors 118, 404 to, e.g., customize or tailor an advertisement, select one advertisement over another, or even to determine whether or not to contribute to set 116.

System 400 is also illustrative of a claimed aspect in which profile 110 is associated with an ID relating to mobile device 406 of shopper 106. As noted supra, connecting shopper 106 to an associated profile 110 can be accomplished by way of device ID 308, wherein the underlying device can be substantially any suitable computing device that includes interface component 102 (and/or another interface such as that described infra), but can specifically be mobile device 406. Mobile device 406 can be substantially any portable electronic device such as a phone, a smart phone, a laptop, a tablet, a media player/recorder, a Personal Digital Assistants (PDA), a camera, a game, a fob, and so on. Mobile device 406 can be a handheld device as well as wearable device and generally includes suitable hardware for one or more types of wireless communication such as cellular, wireless fidelity or “WiFi” (IEEE 802.11x specifications), Bluetooth (IEEE 802.15.x specifications), Near Field Communication (NFC), Radio Frequency Identification (RFID), infrared, etc.

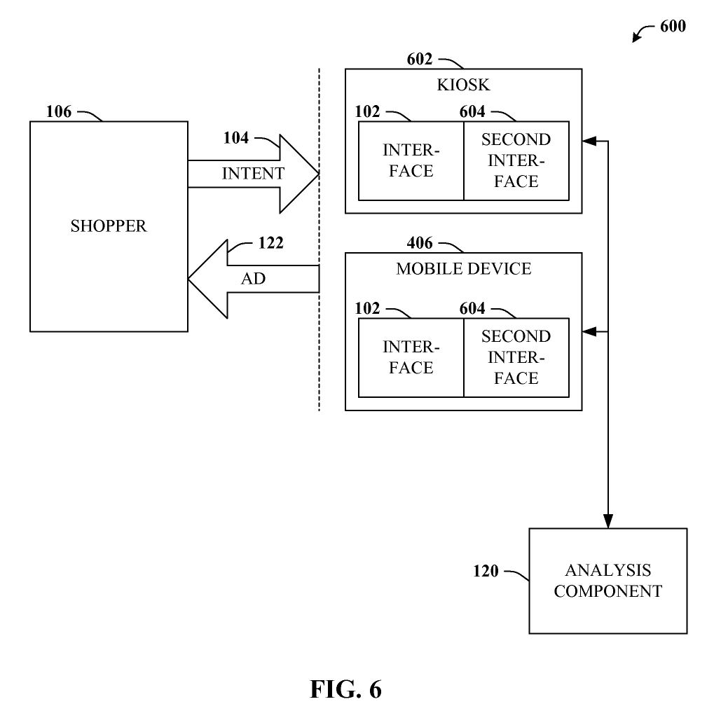

Regardless of the type or nature of mobile device 406, it is to be appreciated and understood that the claimed subject matter can provide unique opportunities to promote the use of mobile devices 406 in connection with consumer transactions as well as to employ unique characteristics of mobile devices 406 for additional features, either or both of which can facilitate numerous benefits to the parties involved. For example, purchasing items with mobile device 406 can be much more convenient for shopper 106 by, e.g., avoiding check-out lines. Likewise, such behavior can result in cost savings to vendors 118, 404, given fewer sales employees may be required. In addition, purchases can be verified, potentially providing a beneficial feedback loop in terms of profile 110 (e.g., transaction history 302, veracity score 310 . . . ); data such as potentially private or personal data can be mobile as well, yet remain secure or secured; and a wide range of other data aggregations and market targeting techniques can also be employed when mobile devices 406 are used in connection with consumer transactions. Furthermore, mobile device 406 can also mitigate the need to, inter alia, determine or deliver all suitable advertisements 122 at once. Rather, suitable advertisements 122 can be delivered during a shopping session at particular times, locations or based upon particular events or circumstances, which is further described in connection with FIG. 6.

With reference now to FIG. 5, system 500 that can employ a veracity rating to solicit vendors in order to facilitate enhanced experiences in connection with consumer shopping or vendor advertising is provided. Typically, system 500 can include ranking component 502 that can also be operatively or communicatively coupled to, or included with all or a subset of the components described herein (e.g., components 102, 108, 114, 120, 402). Ranking component 502 can construct veracity score 310 based at least in part upon transaction history 302.

As detailed, veracity score 310 can relate to a tendency of shopper 106 to fulfill the shopping objectives included in intent parameter 104. Hence, ranking component 502 can increase veracity score 310 for shopper 106 when a transaction associated with intent parameter 104 occurs. For example, when shopper 106 publishes an intent to purchase a plasma television, an actual subsequent purchase of the television will likely boost veracity score 310. Shoppers 106 who tend to fulfill the objectives outlined in intent parameters 104 will customarily have a high veracity score 310 included in associated profile(s) 110. In contrast, ranking component 502 can decrease veracity score 310 when a transaction associated with intent parameter 104 does not occur within a designated period of time. Thus, shoppers who tend to fail at fulfilling objects outlined in intent parameter 104 will generally have a lower veracity score 310 reflected in profile 110.

It should be appreciated that ranking component 502 can update veracity score 310 periodically or based upon event-driven factors (e.g., occurrence of a transaction, passage of time . . . ). Moreover, veracity score 310 need not be positively scaled such that a high veracity score 310 reflects a tendency to fulfill objectives. Rather, veracity score 310 can be scaled such that, e.g. a 1 is the best veracity score 310 whereas a 10 (or 100) is the worst. It should also be underscored that the amount or degree to which a transaction (or lack thereof) affects veracity score 310 need not be discreet or linear. For example, a transaction can contribute to veracity score 310 partially in a continuous fashion and one transaction can be more heavily weighted than another transaction such as transactions relating to an intent to purchase a plasma television versus an intent to purchase eyeliner.

Furthermore, veracity score 310 can include numerous categories that can be employed to segment shoppers 106 based upon respective behavior. Hence, shopper 106 who continuously fails to complete a transaction for the plasma television but who tends to always purchase the eyeliner might not necessarily have an inferior veracity score 310 or an inferior score in one or several categories.

According to an aspect of the claimed subject matter, veracity score 310 or portions thereof (e.g. scores for particular categories) can be utilized by solicitation component 114. For example, solicitation component 114 can propagate all or portions of veracity score 310 to one or more vendors 118, 404. It should be appreciated that a superior veracity score 310 can be indicative of a highly desirable shopper 106 from the point-of-view of vendor 1118, 404. Therefore, it is readily apparent that vendors 118, 404 would like to attract such shoppers, and hence would compete provide all or portions of the suitable advertisement 122 selected by analysis component 120.

In accordance therewith, analysis component 120 can include or be coupled to bidding component 504 that can receive a bid from vendors 118, 404 for selection of suitable advertisement 122. For example, the bid can be employed by analysis component 120 to determine the utility to the respective bidder (e.g., vendor 118, 404) of selecting that bidder's advertisement to shopper 106. Such a determination can, but need not necessarily, affect the selection of suitable advertisement 122. Thus, it is to be appreciated that the bid can be one of many factors employed by analysis component 120 in selecting suitable advertisement 122. Furthermore, it should also be appreciated that the bid can be contingent upon veracity score 310 associated with shopper 106 for whom suitable advertisement 122 is selected. For instance, vendor 118, 404 may indicate that the bid is only applicable to shoppers 106 with certain veracity scores 310 or ratings within one or more individual categories of veracity score 310. Accordingly, the bid can be submitted regardless of whether or not veracity score 310 or other portions of profile 110 are made available to vendors 118, 404.

Referring now to FIG. 6, system 600 is depicted which illustrates various example topologies in connection with the claimed subject matter. In particular, system 600 can include interface component 102 that can receive intent parameter 104 from shopper 106 as well as analysis component 120 that can, inter alia, examine set 116 and select suitable advertisement 122 based upon intent parameter 104, as substantially described herein.

With the foregoing in mind, it can be particularly pointed out that interface component 102 can be extant in either of kiosk 602, mobile device 406, as well as substantially any other suitable device (not shown). Likewise, all or portions of other components detailed herein can be included in or coupled to kiosk 602, mobile device 406, etc. One potentially relevant aspect is that interface component 102 need not be the vehicle by which suitable advertisement 122 is delivered and/or displayed to shopper 106, although, it is understood that interface component 102 can in many cases be so. Rather, interface component 102 can receive intent parameter 104, while second interface component 604 receives (and/or outputs) suitable advertisement 122. Second interface component 604 can be substantially similar to (or identical to) interface component 102, yet distinguished for the purposes of this discussion by input versus output or the types of data the interface is configured to transmit or receive.

In accordance therewith, shopper 106 can input intent parameter 104 to kiosk 602 located near, say, a shopping mall entrance (or to another device such as mobile device 406) and subsequently receive suitable advertisement 122 by way of interface component 102 included in kiosk 602 (or mobile device 406). However, shopper 106 might also input intent parameter 104 to kiosk 602, yet receive suitable advertisement 122 by way of second interface component 604 of mobile device 406. Thus, a potentially more robust (e.g., larger form factor, specifically tailored features or l/O devices, etc.) interface component 102 can be employed to enter intent parameter 104, yet shopper 106 is not required to remain at kiosk 602 for results. Rather, shopper 106 can browse or accomplish other related tasks before suitable advertisement 122 is provided. As another example, employ interface component 102 included in a desktop computer at home to input intent parameter 104, then view the display of suitable advertisement 122 from the second interface component 604 of kiosk 602 upon arriving at the intended destination 208 (e.g., the shopping mall).

While suitable advertisement 122 can in many cases be provided virtually instantaneously, allowing degrees of latency can provide several benefits such as allowing certain event-based, location-based, or time-based occurrences to trigger suitable advertisement 122. Moreover, vendors 118, 404 can be apprised of, digest, and potentially customize advertisements received as set 116, which can be based upon solicitations from solicitation component 114 that include portions of intent parameter 104 (e.g., current objectives), profile 110 (e.g., veracity score 310), or any other suitable information that does not conflict with preferences 304 of shopper 106.

With reference now to FIG. 7, system 700 that can aid with various determinations or inferences is depicted. Typically, system 700 can include identification component 108, analysis component 120, selection component 402, and ranking component 502, which in addition to or in connection with what has been described supra, can also make various inferences or intelligent determinations. For example, identification component 108 can intelligently associate shopper 106 with a template profile such as when profile 110 does not already exist or cannot be accessed. Identification component 108 can also intelligently determine a gift suitable for recipient based upon a profile 110 for the recipient or suitable template profile inferred for the recipient. Moreover, identification component 108 can also intelligently integrate multiple profiles 110 into a single comprehensive profile 110 as well as intelligently infer shopping preferences or demographic data based upon, e.g. transaction history 302 or other appropriate data sets.

Analysis component 120 and selection component 402 can employ substantially similar data sets to intelligently determine suitable advertisement 122 and appropriate vendor 404, respectively. In addition, analysis component 120 can intelligently determine a weight to place upon a bid from vendors 118, 404 in making the selection of suitable advertisement 122. Furthermore, ranking component 502 can intelligently determine or infer an amount, weight, or step by which to adjust veracity score 310 upon occurrence (or absence) of an associated transaction, as well as measure the relative affects on individual categories of veracity score 310.

In addition, system 700 can also include intelligence component 702 that can provide for or aid in various inferences or determinations. It is to be appreciated that intelligence component 702 can be operatively coupled to all or some of the aforementioned components. Additionally or alternatively, all or portions of intelligence component 702 can be included in one or more of the components 108, 120, 402, 502. Moreover, intelligence component 702 will typically have access to all or portions of data sets described herein or otherwise suitable to the claimed subject matter, such as data store 112, and can furthermore utilize previously intelligently determined or inferred data.

Accordingly, in order to provide for or aid in the numerous inferences described herein, intelligence component 702 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g. naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

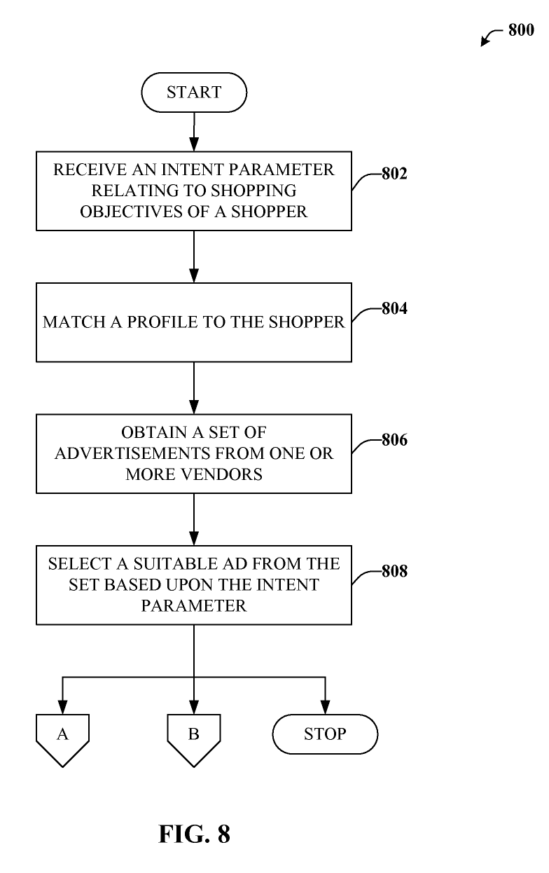

FIGS. 8, 9, and 10 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 8, exemplary method 800 for facilitating richer experiences in connection with consumer shopping and/or vendor advertising is illustrated. Generally, at reference numeral 802, an intent parameter relating to one or more shopping objectives of a shopper can be received. Accordingly, the intent parameter can relate to a shopping list that includes items intended for purchase, a list that includes intended recipients of purchased items, a location of the shopper or a destination where purchases or transactions are intended to be made, time-related or budget-related aspects of a shopping session, or another shopping objective of the shopper.

At reference numeral 804, a profile can be matched to the shopper. Such can be accomplished by ascertaining an ID associated with the shopper (either input by the shopper or transmitted, potentially automatically or as an acknowledgement or response to a query, by an associated device). In an aspect, the profile can be newly created, potentially employing a template profile that includes common features of identifiable shopper types. In addition, a profile can also be matched or constructed for another party, such as an intended recipient of a purchase by the shopper. Hence, any feature described herein reliant on a profile of the shopper can be extrapolated to the intended recipient based upon that particular profile. For example, suitable advertisements selected based upon the profile of a shopper can also be selected based upon the profile of the intended recipient and can therefore, e.g. provide gift ideas to the shopper.

At reference numeral 806, a set of advertisements from one or more vendors can be obtained. It is to be appreciated that the set of advertisements can be obtained prior to or subsequent to the act of receiving an intent parameter described at reference numeral 802. At reference numeral 808, a suitable advertisement from the set of advertisements can be selected based at least in part upon the intent parameter. The selection can be approached in one of several ways (or a combination thereof). For example, the existence of certain data in the intent parameter can automatically trigger the suitable advertisement based preconceived constraints or certain data or combinations of data included in the intent parameter can be dynamically inferred to favor some ads over others in terms of suitability.

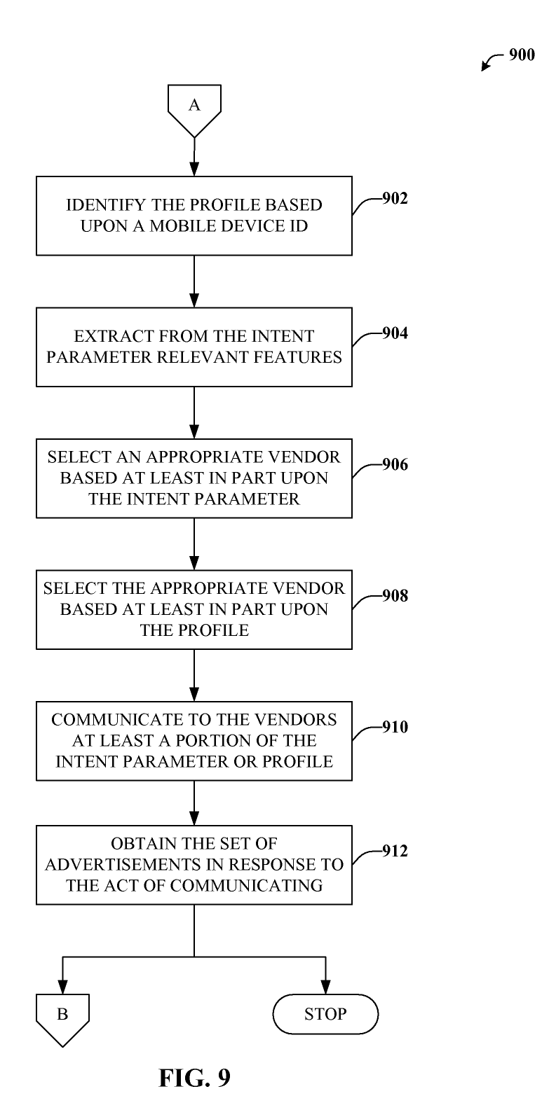

Referring to FIG. 9, exemplary method 900 for soliciting vendors in order to facilitate richer experiences in connection with consumer shopping and/or vendor advertising is depicted. To these and additional ends, at reference numeral 902, the profile matched to the shopper at act 804 can be identified based upon a mobile device ID, and, at reference numeral 904 various relevant features can be extracted from the intent parameter received at act 802. Relevant features can include, but need not necessarily be limited to, a shopping list that includes one or more items intended for purchase, a list that includes one or more intended recipients of purchased items, a location of the shopper, an intended destination of the shopper, an intended length of time of a shopping session, or an intended budget of the shopping session.

At reference numeral 906, an appropriate vendor can be selected based at least in part upon the intent parameter such as one or more of the relevant features extracted at act 904. At reference numeral 908, an appropriate vendor can be selected based at least in part upon the profile matched to the shopper at act 804. In any case, whether the appropriate vendor is selected based upon the intent parameter, based upon the profile, or based upon a combination of the two, at act 910, at least a portion of one of the intent parameter or the profile can be communicated to the one or more vendors. In certain cases, communication of the intent parameter or profile can be limited both in terms of what portions are communicated and to whom these portions are communicated. For example, information deemed personal or not to be shared may be restricted and/or the portions that are shared can be limited just to the appropriate vendors selected at either act 906 or 908.

At reference numeral 912, the set of advertisements obtained at act 806 can be obtained in response to the act of communicating detailed at reference numeral 910. By receiving the set of advertisements in response rather than in advance, say, prior to receiving the intent parameter, one or more of the set of advertisements can be specifically tailored to shopper based upon the intent parameter or the profile of shopper without knowing the need to anticipate this information.

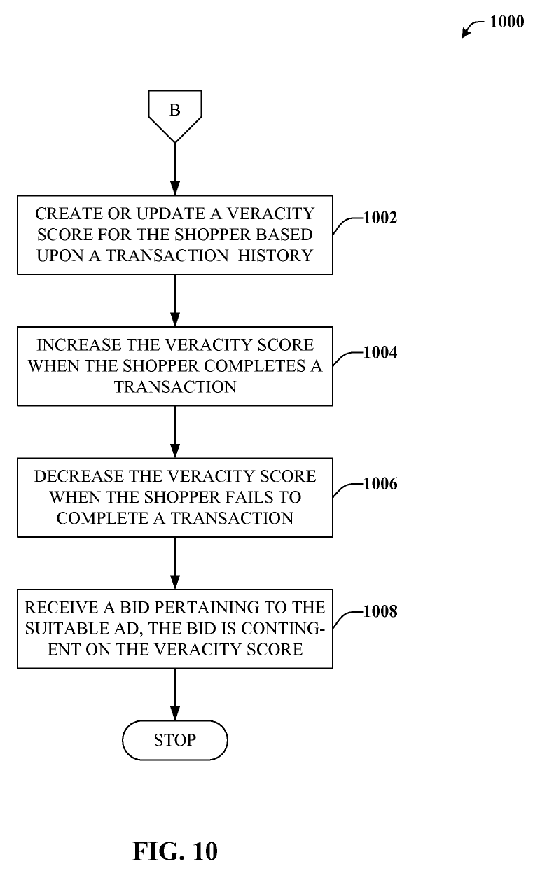

With reference now to FIG. 10, method 1000 for utilizing a veracity rating in connection with facilitating richer experiences for consumer shopping and/or vendor advertising is illustrated. At reference numeral 1002 a veracity score for the shopper can be created or updated based at least in part upon a transaction history. Typically, both the veracity score and the transaction history can be included in the profile matched to the shopper at act 804. The veracity score can relate to a tendency of the shopper to fulfill the shopping objectives included in intent parameter and can be included in the data communicated to the vendors at act 910.

At reference numeral 1004, the veracity score can be increased when the shopper completes a transaction in connection with the intent parameter, while at reference numeral 1006, the veracity score can be decreased when the shopper fails to complete a transaction in connection with the intent parameter within a determined time period. In either case, the veracity score can be updated on a periodic basis or based upon the transaction or absence of the transaction after the lapse of the time period.

At reference numeral 1006, a bid from the one or more vendors can be received, wherein the bid is for selection of the suitable ad and contingent upon a veracity score of the shopper. In particular, a successful bid can enhance the likelihood that the bidder's advertisement will be selected as the suitable advertisement at act 808. Moreover, the bid can be cast by the vendor, whether or not the vendor is exposed to any portion of the intent parameter or profile.

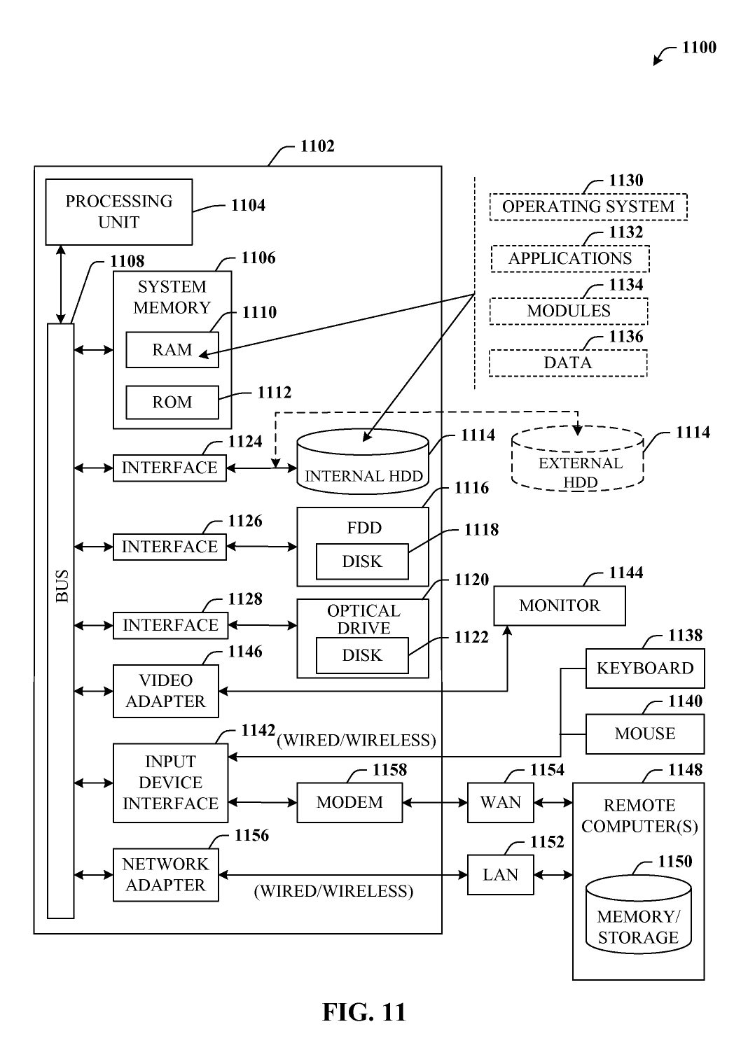

Referring now to FIG. 11, there is illustrated a block diagram of an exemplary computer system operable to execute the disclosed architecture. In order to provide additional context for various aspects of the claimed subject matter, FIG. 11 and the following discussion are intended to provide a brief, general description of a suitable computing environment 1100 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, the exemplary environment 1100 for implementing various aspects of the claimed subject matter includes a computer 1102, the computer 1102 including a processing unit 1104, a system memory 1106 and a system bus 1108. The system bus 1108 couples to system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 110 and random access memory (RAM) 1112. A basic input/output system (BIOS) is stored in a non-volatile memory 110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the claimed subject matter can be implemented with various commercially available operating systems or combinations of operating systems.

A user can enter commands and information into the computer 1102 through one or more wired/wireless input devices, e.g. a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g. a wide area network (WAN) 1154. Such LAN and WAN networking environments are commonplace in offices and companies, and facilitate enterprise-wide computer networks, such as intranets, all of which may connect to a global communications network, e.g. the Internet.

When used in a LAN networking environment, the computer 1102 is connected to the local network 1152 through a wired and/or wireless communication network interface or adapter 1156. The adapter 1156 may facilitate wired or wireless communication to the LAN 1152, which may also include a wireless access point disposed thereon for communicating with the wireless adapter 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “10BaseT” wired Ethernet networks used in many offices.

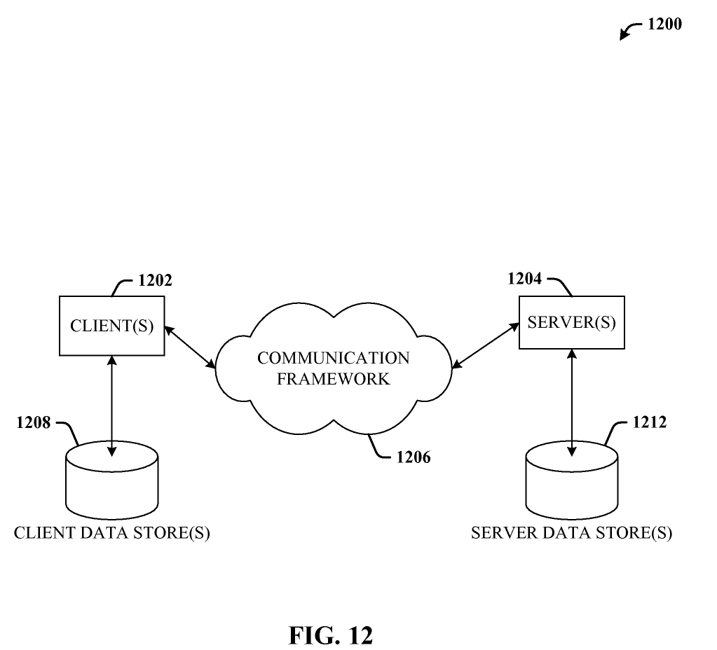

Referring now to FIG. 12, there is illustrated a schematic block diagram of an exemplary computer compilation system operable to execute the disclosed architecture. The system 1200 includes one or more client(s) 1202. The client(s) 1202 can be hardware and/or software (e.g., threads, processes, computing devices). The client(s) 1202 can house cookie(s) and/or associated contextual information by employing the claimed subject matter, for example.

The system 1200 also includes one or more server(s) 1204. The server(s) 1204 can also be hardware and/or software (e.g., threads, processes, computing devices). The servers 1204 can house threads to perform transformations by employing the claimed subject matter, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates enhanced experiences in connection with consumer shopping and/or vendor advertising, comprising:
an interface component that receives an intent parameter that relates to a shopping objective of a shopper;
an identification component that associates the shopper with a profile;
a solicitation component that receives a set of advertisements from one or more vendors; and
an analysis component that examines the set of advertisements and that selects a suitable advertisement for the shopper based at least in part upon the intent parameter.

2. The system of claim 1, the intent parameter is at least one of a shopping list that includes one or more items intended for purchase, a list that includes one or more intended recipients of purchased items, a location of the shopper, an intended destination of the shopper, an intended length of time of a shopping session, or an intended budget of the shopping session.

3. The system of claim 1, the profile includes at least one of a transaction history associated with the shopper, a shopping preference, demographic data, or a veracity score associated with the shopper.

4. The system of claim 1, the analysis component selects the suitable advertisement further based upon the profile.

5. The system of claim 1, the profile is associated with a mobile device ID.

6. The system of claim 1, further comprising a selection component that identifies appropriate vendors based at least in part upon the intent parameter.

7. The system of claim 6, the selection component identifies appropriate vendors further based upon the profile.

8. The system of claim 1, the solicitation component transmits at least a portion of the intent parameter to the one or more vendors and receives the set of advertisements in response.

9. The system of claim 1, the solicitation component transmits at least a portion of the profile to the one or more vendors and receives the set of advertisements in response.

10. The system of claim 1, further comprising a ranking component that constructs a veracity score for the shopper based at least in part upon a transaction history.

11. The system of claim 10, the ranking component increases the veracity score for the shopper when a transaction associated with the intent parameter occurs.

12. The system of claim 10, the ranking component lowers the veracity score for the shopper when a transaction associated with the intent parameter does not occur within a designated period of time.

13. The system of claim 1, the interface component is included in at least one of the mobile device or a kiosk.

14. The system of claim 1, further comprising a bidding component that receives a bid from the one or more vendors for selection of the suitable advertisement.

15. The system of claim 14, the bid is contingent upon a veracity score associated with the shopper for whom the suitable advertisement is selected.

16. The system of claim 1, the analysis component transmits the suitable advertisement to at least one of the interface component or a second interface component, the second interface component is included in the mobile device.

17. A method for facilitating richer experiences in connection with consumer shopping and/or vendor advertising, comprising:
receiving an intent parameter relating to one or more shopping objectives of a shopper;
matching a profile to the shopper;
obtaining a set of advertisements from one or more vendors; and
selecting a suitable advertisement from the set of advertisements based at least in part upon the intent parameter.

18. The method of claim 17, further comprising at least one of the following acts:
identifying the profile based upon a mobile device ID;
extracting from the intent parameter at least one of a shopping list that includes one or more items intended for purchase, a list that includes one or more intended recipients of purchased items, a location of the shopper, an intended destination of the shopper, an intended length of time of a shopping session, or an intended budget of the shopping session;
selecting an appropriate vendor based at least in part upon the intent parameter;
selecting an appropriate vendor based at least in part upon the profile;
communicating to the one or more vendors at least a portion of one of the intent parameter or the profile; or
obtaining the set of advertisements in response to the act of communicating to the one or more vendors.

19. The method of claim 17, further comprising at least one of the following acts:
creating or updating a veracity score for the shopper based at least in part upon a transaction history;
increasing the veracity score when the shopper completes a transaction in connection with the intent parameter;
decreasing the veracity score when the shopper fails to complete a transaction in connection with the intent parameter within a determined time period; or
receiving a bid from the one or more vendors pertaining to selection of the suitable advertisement, the bid is contingent upon the veracity score.

20. A system for facilitating more robust experiences in connection with consumer shopping and/or vendor advertising, comprising:
means for acquiring an intent parameter relating to an objective of a shopper;
means for associating the shopper with a profile;
means for receiving a set of advertisements from one or more vendors; and
means for utilizing the intent parameter for determining a suitable advertisement from among the set of advertisements.
